(19) United States
(12) Patent Application Publication
(10) Pub. No.: US 2026/0221505 A1
(43) Pub. Date: Jul. 30, 2026

(54) SOLID ELECTROLYTE AND PREPARATION METHOD THEREFOR, AND BATTERY

(71) Applicant: EASTERN INSTITUTE FOR ADVANCED STUDY, Ningbo (CN)

(72) Inventors: Xiaona LI, Ningbo (CN); Xueliang SUN, Ningbo (CN); Junyi YUE, Ningbo (CN); Simeng ZHANG, Ningbo (CN)

(73) Assignee: EASTERN INSTITUTE FOR ADVANCED STUDY, Ningbo (CN)

(21) Appl. No.: 19/629,319

(22) Filed: Mar. 26, 2026

Related U.S. Application Data
(63) Continuation of application No. PCT/CN2025/109661, filed on Jul. 21, 2025.

(30) Foreign Application Priority Data
Jul. 29, 2024 (CN) 202411018267.3
Jul. 29, 2024 (CN) 202411018358.7
Jul. 29, 2024 (CN) 202411024548.X
Jul. 4, 2025 (CN) 202510924855.1
Jul. 4, 2025 (CN) 202510924856.6

(51) Int. Cl. H01M 10/0562; H01M 10/0525

(52) U.S. Cl. CPC H01M 10/0562; H01M 10/0525; H01M 2300/0065

(57) ABSTRACT

The present invention belongs to the technical field of battery materials, and relates to a solid electrolyte and a preparation method therefor, and a battery. The solid electrolyte comprises a carrier salt CₐN_{b} and a Van der Waals crystal MB_{y} having a Van der Waals crystal structure; some of the anion donors of N in the CₐN_{b} are replaced with some of the elements B in the compound having a Van der Waals crystal structure, such that the carrier salt and the compound having a Van der Waals crystal structure form a framework structure; the dissociated cation donors of C are filled into the gap of the frame structure, some of which act as carriers for transmission in the frame structure, and the others of which form a nanocrystalline with MB_{y} or B.

### CROSS-REFERENCE TO RELATED APPLICATIONS

The application claims priority to Chinese patent application No. 202411018267.3, No. 202411018358.7 and No. 202411024548.X filed on Jul. 29, 2025, Chinese patent application No. 202510924855.1 and No. 202510924856.6 filed on Jul. 4, 2025, the entire contents of which are incorporated herein by reference.

### TECHNICAL FIELD

The present disclosure relates to the technical field of battery materials, and relates to a solid electrolyte and a preparation method therefor, and a battery.

### BACKGROUND

All-solid-state batteries, due to their high energy density and high safety, have become the most promising next-generation energy storage technology. Developing inorganic solid electrolytes that possess high ionic conductivity (>1×10⁻³ Scm⁻¹), a wide electrochemical stability window (>4 V vs Li⁺/Li), excellent processing and forming performance, and controllable cost is the key to realizing the practical application of all-solid-state batteries. Inorganic solid electrolyte systems disclosed in the relevant technical literature can be classified into oxide material systems, sulfide material systems, and halide material systems. These material systems have different characteristic crystal structures, and conduction ions are transported along lattice channels with smaller migration activation energy and relatively gentle changes. However, these material systems respectively have some inherent limitations.

The conventional liquid ionization battery field has widely adopted electrolyte (solution) engineering strategies to design electrolyte compositions by using different solvents, additives, and metal salts to improve low-temperature performance and flammability of the electrolyte solution in a targeted manner and control solvation structures and solid electrolyte interphase (SEI) compositions formed, thereby developing the electrolyte solution. However, the electrolyte (solution) engineering strategies are difficult to apply to solid electrolyte development. This is due to the fact that the ion transport of the solid electrolyte tends to depend on a specific crystal structure, for example, halide Li₃InCl₆ having a layered structure (Patent Document: CN 111916820 A), halide Li_{0.388}Ta_{0.238}La_{0.475}Cl₃ having UCl₃-type lattices (Patent Document: CN 113772729 A), etc.; therefore, electrolyte composition control can only be achieved by doping and substitution, and there is no flexibility in introducing beneficial elements. While dopant ions need to have similar ionic radii and valences as ions of target lattice sites, the range of options is limited.

Furthermore, during cycling of liquid batteries, although a part of an organic electrolyte solution decomposes on a surface of an electrode and forms SEI, the ionic conductivity of the remaining electrolyte solution is not affected, and the surface of the electrode can still be wetted through gaps of an SEI film; however, in all-solid-state batteries, the decomposition of the solid electrolyte on the surface of the electrode will disrupt its ion transport channels, which greatly reduces the ionic conductivity, causes the electrolyte/electrode interface impedance to rise suddenly, and becomes an important factor for deterioration of battery performance and failure. Therefore, strategies for designing solid electrolyte compositions through electrolyte engineering to further regulate SEI have been difficult to achieve.

### SUMMARY

In view of the problems existing in the prior art, the present disclosure provides a solid electrolyte and a preparation method therefor, and a battery, thereby improving the ionic conductivity, being simple in synthesis technology route, being low in raw material cost, and having electrochemical performance.

The present disclosure is achieved by the following technical solutions:

In a first aspect, the present disclosure provides a solid electrolyte having a general formula (CₐN_{b})_{X}_{^{−}}MB_{y},
where MB_{y} is van der Waals crystals as a structural framework, and y is a number of atoms of B element; CₐN_{b} is a carrier salt, and a and b are numbers of atoms of cation donors C and anion donors N in the carrier salt, respectively; ₓ is a stoichiometric ratio of CₐN_{b} to MB_{y};
some of the anion donors N are replaced with B positions in MB_{y}, forming a framework with carrier ionic migration channels.

Preferably, the van der Waals crystals are one or more of halide van der Waals crystals, sulfide van der Waals crystals, and oxide van der Waals crystals;

M in the MB_{y} is one or more of Zr, Hf, Ta, Nb, Al, Fe, Ga, In, Mo, W, Y, Ti, Si, B, and Sb; B is one or more of F, Cl, Br, I, S, or O.

Preferably, the anion donors N include polyanions XOₘⁿ⁻, derivative groups XₘO₃ₘ₊₁ⁿ⁻ of the polyanions, or simple anions;
the simple anions are one or more of halogen, OH⁻, NH₂⁻, O₂²⁻, O²⁻, S²⁻, or N³⁻;
in the polyanions XOₘⁿ⁻ or the derivative groups XₘO₃ₘ₊₁ⁿ⁻ of the polyanions, X is one or more of B, S, P, Si, As, Mo, W, or C; m is 2-4, and n is a number of charges.

Preferably, the anion donors N are polyanions XOₘⁿ⁻ or derivative groups XₘO₃ₘ₊₁ⁿ⁻ of the polyanions, and the B element in the MB_{y} is substituted with XOₘⁿ⁻ or XₘO₃ₘ₊₁ⁿ⁻.

Preferably, the cation donors C are Li⁺, Na⁺, Ag⁺, Cu⁺, or K⁺, where a coordination number of Li⁺ ranges from 3 to 5, and a coordination number of Na⁺ ranges from 7 to 9.

Preferably, for the dissociated cation donors C, a part is transported as carriers in the framework structure, and the other part forms nanocrystals with MB_{y} or B, where a content of the nanocrystals in the solid electrolyte is <30 wt. %.
the nanocrystals include CₑMB_{f} and CB, where e and fin the CₑMB_{f} are stoichiometric numbers of the cation donors C and MB, respectively; a content of the nanocrystals in the solid electrolyte is <30 wt. %;
in the framework structure, (CₐN_{b})_{X}_{^{−}}MB_{y} is in a form of particles, CₑMB_{f} or CB is attached to surfaces of the particles, the particles are in an amorphous phase, and the nanocrystals are in a crystalline phase.

Preferably, the solid electrolyte (CₐN_{b})_{X}_{^{−}}MB_{y} is of an amorphous or near-amorphous structure, with x ranging from 0.2 to 2 and y ranging from 3 to 6.

In a second aspect, the present disclosure provides a preparation method for a solid electrolyte, including the following steps:
in an anhydrous and oxygen-free inert atmosphere, mixing CₐN_{b} and MB_{y} according to a stoichiometric ratio by a mechanical ball milling method to make a solid-phase reaction to obtain the solid electrolyte (CₐN_{b})_{X}_{^{−}}MB_{y}.

Preferably, control parameters of the mechanical ball milling method include: a diameter of ball milling beads of 3 mm to 10 mm; a total mass ratio of the ball milling beads to raw materials of 60:1 to 20:1; a ball milling time of 1 h to 30 h; a rotation speed of a ball mill of 400 r/min to 800 r/min.

In a third aspect, the present disclosure provides a battery, including the solid electrolyte.

Compared with the prior art, the present disclosure has the following beneficial effects:

According to the solid electrolyte provided by the present application, the solid electrolyte includes a carrier salt CₐN_{b} and van der Waals crystals MB_{y} having a van der Waals crystal structure, part of anion donors N in CₐN_{b} replace a part of B element in a compound having the van der Waals crystal structure, such that the carrier salt and the compound having the van der Waals crystal structure constitute a framework structure; part of the anion donors N of the carrier salt replace a part of the B element, such that part of the cation donors C are released by dissociation, part of the cation donors C released by dissociation are transported as carriers within the framework structure, and another part thereof form nanocrystals with MB_{y} or B parts. In this electrolyte, the van der Waals crystals MB_{y} act as a solid solvent, can dissociate various salts CₐN_{b} and form a solid-solution type electrolyte, have ubiquitous properties, and help to extend an electrolyte system. The solid electrolyte achieves solid electrolyte engineering, the functionalized solid electrolytes are developed, including solid electrolytes with high air stability, solid electrolytes capable of matching Li metal negative electrodes, and solid electrolytes supporting very low temperatures and high rates.

Further, an open framework structure is formed by the connection of carrier salts with van der Waals crystals, which has a cross-linked network framework and through three-dimensional channels, and vacancies therein are filled with the cation donors C. The free volume of the structure is large, the hopping transport of the cation donors C therein bears small repulsion of cations of the framework, and thus the ionic conductivity is high. In addition, since the cross-linked network framework is easily deformed, the materials are good in processing and forming performance, do not require a high-temperature condition, are easy to form a dense electrolyte sheet upon cold press forming, have good electrical contact between particles, and have small interfacial resistance. They have amorphous characteristics, are independent of specific crystal structure and elemental composition, have a wide range of composition control, and allow doping of multiple beneficial ions.

Further, a material system provided by embodiments of the present application is high in ionic conductivity, high in oxidation limit, and wide in composition-controllable range; in addition, the synthesis technology route is simple, the all-solid-state battery based on the electrolyte material system can achieve fast charge and service at low temperatures.

Further, the solid electrolyte provided by the present application has high ionic conductivity, the synthesis technology route is simple, the cost of the raw materials is low, and the electrochemical performance is good.

Further, the preparation method provided by embodiments of the present application is simple in process and short in cycle, does not involve high-temperature and vacuum sintering operations, does not generate irritating gas, and can significantly reduce energy consumption and environmental pollution.

### BRIEF DESCRIPTION OF THE DRAWINGS

FIG. 1 is a diagram of an open framework structure of a Li₂O—ZrCl₄ solid electrolyte provided by Embodiment 1 of the present disclosure.

FIG. 2 is an electrochemical alternating-current impedance spectrogram of a halide solid electrolyte according to an embodiment of the present application; in the figure, the abscissa represents resistance at a solid part in ohms (Ω); the ordinate represents resistance at a virtual part in ohms (Ω), where FIG. (a) is an electrochemical alternating-current impedance spectrogram of Li₂O—ZrCl₄, Li₂S—ZrCl₄, Li₃N—ZrCl₄, and a halide solid electrolyte Li₂ZrCl₆ provided by Comparative Example 1, and spectral lines a, b, c, and d in the figure represent Li₂O—ZrCl₄, Li₂S—ZrCl₄, Li₃N—ZrCl₄, and Li₂ZrCl₆, respectively; FIG. (b) is an electrochemical alternating-current impedance spectrogram of Na₂S—ZrCl₄; FIG. (c) is an electrochemical alternating-current impedance spectrogram of Ag₂O@-ZrCl₄.

FIG. 3 is an X-ray absorption fine structure spectrogram of Li₂SO₄—ZrCl₄, Li₃PO₄—ZrCl₄, Li₂CO₃—ZrCl₄ electrolytes provided by embodiments of the present disclosure. In the figure, the abscissa “R” represents a distance; the ordinate “FT” represents a modulus of a k³-weighted expanded X-ray fine structure after Fourier transformation, where FIG. (a) is Li₂SO₄—ZrCl₄, FIG. (b) is Li₃PO₄—ZrCl₄, and FIG. (c) is Li₂CO₃—ZrCl₄.

FIG. 4 is a graph of a pair distribution function of a Li₂SO₄—ZrCl₄ solid electrolyte provided by embodiments of the present disclosure. In the figure, the abscissa “r” represents a distance; the ordinate “G” represents an atom pair distribution function. In the figure, FIG. (a) is Li₂O—ZrCl₄, FIG. (b) is Li₂SO₄—ZrCl₄, FIG. (c) is Li₃PO₄—ZrCl₄, and FIG. (d) is Li₂CO₃—ZrCl₄.

FIG. 5 is an X-ray diffraction spectrum of Li₂CO₃—HfCl₄, Li₂SO₄—HfCl₄, Li₂CO₃—ZrCl₄, Li₂SO₄—ZrCl₄, Li₂O—TaCl₅, ⅔Li₃PO₄—ZrCl₄, Li₂C₂O₄—TaCl₅ lithium salt-van der Waals crystal solid electrolytes in embodiments of the present disclosure. In the figure, the abscissa represents a diffraction angle (2 Theta) in degrees (°); the ordinate represents diffraction intensity.

FIG. 6 is an X-ray diffraction spectrum of a solid electrolyte Li₂O—ZrCl₄ prepared in Embodiment 1 of the present disclosure using different ball milling times. In the figure, the abscissa represents a diffraction angle (2 Theta) in degrees (°); the ordinate represents diffraction intensity.

FIG. 7 is a high-resolution cryo-transmission electron microphotograph of a solid electrolyte (Li₂SO₄)ZrCl₄ prepared in embodiments of the present application; in the figure, nanocrystals are LiCl, and diffraction spots are in a picture in the lower right corner.

FIG. 8 is linear scanning curves of solid electrolytes Li₂O—ZrCl₄, Li₃PO₄—ZrCl₄ provided in embodiments of the present application and a solid electrolyte Li₂ZrCl₆ provided in Comparative Example 1. In the figure, the abscissa represents voltage in volts (V); the ordinate represents current density in milliamperes per gram (mAg⁻¹).

FIG. 9 shows electrochemical performance of all solid-state lithium batteries assembled in Application Example 1 of the present application for the first 100 weeks at 2 C rate. In the figure, the abscissa represents a number of cycles; the left ordinate represents specific capacity in milliampere hours per gram (mAhg⁻¹); the right ordinate represents coulombic efficiency.

FIG. 10 shows electrochemical performance of all solid-state lithium batteries assembled in Application Example 2 of the present application for the first 100 weeks at 5 C rate. In the figure, the abscissa represents a number of cycles; the left ordinate represents specific capacity in milliampere hours per gram (mAhg⁻¹); the right ordinate represents coulombic efficiency.

FIG. 11 shows electrochemical performance of all solid-state lithium batteries assembled in Application Example 3 of the present application for the first 150 weeks at −30° C. In the figure, the abscissa represents a number of cycles; the left ordinate represents specific capacity in milliampere hours per gram (mAhg⁻¹); the right ordinate represents coulombic efficiency.

FIG. 12 is a ⁷Li solid nuclear magnetic spectrum of the solid electrolytes with low coordination number lithium environment of Embodiment 33, Embodiment 30, Embodiment 34, and Embodiment 2 of the present disclosure.

FIG. 13 is a ²³Na solid nuclear magnetic spectrum of the solid electrolyte of Embodiment 22 of the present disclosure.

### DETAILED DESCRIPTION OF THE EMBODIMENTS

In order to provide a better understanding of the solutions of the present disclosure for those skilled in the art, the technical solutions in the embodiments of the present disclosure will be clearly and completely described below with reference to the accompanying drawings in the embodiments of the present disclosure.

A solid electrolyte, having a general formula (CₐN_{b})_{X}_{^{−}}MB_{y}, where MB_{y} is van der Waals crystals as a structural framework, and y is a number of atoms of B element; CₐN_{b} is a carrier salt, and a and b are numbers of atoms of cation donors C and anion donors N in the carrier salt, respectively; ₓ is a stoichiometric ratio of CₐN_{b} to MB_{y};
of the anion donors N are replaced with B positions in MB_{y}, forming a framework structure with carrier ionic migration channels; gaps of the framework structure are filled with dissociated cation donors C to form nanocrystals with MB_{y} or B, that is, CₑMB_{f} and CB, but a force of action between C and MB_{y} or B is weak, so that C can shuttle and migrate in a larger and three-dimensional framework, and the migration rate of the cation donors C in the framework structure is high, exhibiting high room-temperature ionic conductivity.
0.2<X<2, y is 3-6, and x is a mixed molar ratio of CₐN_{b} to MB_{y} when MB_{y} is set to 1 mole.

Exemplarily, CₐN_{b} can be Li₂O, Li₂S, Li₃N, LiOH, Li₃N, Li₂O₂, LiBO₂, Li₄SiO₄, Li₂MoO₃, Li₂CO₃, Li₃PO₄, Li₂SO₄, Li₂SiO₃, Li₂C₂O₄, Na₂O, Na₂S, Na₃N, NaOH, Na₃N, Na₂O₂, NaBO₂, Na₄SiO₄, Na₂MoO₃, Na₂CO₃, Na₃PO₄, Na₂SO₄, K₂O, K₂S, K₃N, KOH, K₂O₂, KBO₂, K₄SiO₄, K₂MoO₃, K₂CO₃, K₃PO₄, K₂SO₄, Ag₂O, Ag₂S, Ag₃N, AgOH, Ag₃N, Ag₂O₂, AgBO₂, Ag₄SiO₄, Ag₂MoO₃, Ag₂CO₃, Ag₃PO₄, Ag₂SO₄.

MB_{y} is a compound having a van der Waals crystal structure, and in some embodiments of the present disclosure, MB_{y} is one or more of a halide van der Waals crystal material, a sulfide van der Waals crystal material, and an oxide van der Waals crystal material.

Preferably, M is one or more of Zr, Hf, Ta, Nb, Al, Fe, Ga, In, Mo, W, Y, Ti, or V; b is one or more of halogen, S, or O, and MB_{y} may also be one or more of SiI₄, BI₃, SbI₃.

Exemplarily, MB_{y} can be ZrCl₄, HfCl₄, TaCl₅, NbCl₅, AlCl₃, FeCl₃, GaCl₃, InCl₃, YCl₃, MoCl₅, MoCl₆, WCl₆, SiI₄, BI₃, SbI₃, NbOCl₃, AlOCl, WOCl₄, TiOCl₃, VOCl.

Van der Waals crystals are also known as inorganic molecular crystals, are formed by the stacking of zero-dimensional, one-dimensional, or two-dimensional structural elements under the action of van der Waals forces (intermolecular forces), structural elements of MB_{y} van der Waals crystals include zero-dimensional [MB_{y}] polyhedrons (e.g., [SiI₄] tetrahedrons in SiI₄ van der Waals crystals) and dimers/multimers thereof (such as [TaCl₅]₂ dimers in TaCl₅ van der Waals crystals), one-dimensional chain-like multimers [MB_{y}]ₙ formed by [MB_{y}] polyhedrons sharing edges (such as [ZrCl₄]ₙ chains in ZrCl₄ van der Waals crystals), and two-dimensional layer-like multimers [MB_{y}] formed by [MB_{y}] polyhedrons sharing edges (such as [AlCl₃]ₙ layers in AlCl₃ van der Waals crystals);
in the present disclosure, the dissociation capacity of the van der Waals crystal MB_{y} for CₐN_{b} is on one hand due to the fact that the van der Waals crystals MB_{y} have a characteristic structure in which the structural elements are linked by van der Waals forces, similar to a solvent from a liquid electrolyte solution, the van der Waals forces are easily destroyed under the action of mechanical energy, providing good solid phase diffusion conditions that help the [MB_{y}] (or [MB_{y}]) structural elements to form atomic-scale contacts with a salt CₐN_{b}; on the other hand, since M cations in its structural elements have a strong interaction with N anions of the salt CₐN_{b}, similar to solvation in the liquid electrolyte solution, the dissociation and reconstitution of C and N in CₐN_{b} are achieved.

In the present disclosure, the solid electrolyte (CₐN_{b})_{X}_{^{−}}MB_{y} is of an amorphous or near-amorphous structure. In certain embodiments, the solid electrolyte includes a nanocrystalline phase that is one or more of CₑMB_{f}, CB, or residual raw material phases, which is embedded in an amorphous matrix or distributed on a particle surface. The solid electrolyte (CₐN_{b})_{X}_{^{−}}MB_{y} appears as a particle at the macroscale, with a small quantity of nanocrystalline phases present at the surface and with a nanocrystalline phase content <30 wt. %; by controlling the composition and size of the nanocrystalline phases, the air stability of the material can be improved, and the grain boundary electronic conductivity after the powder is cold-pressed is reduced. In the process of preparing solid electrolytes using a mechanical ball milling method, CₑMB_{f} first appears and gradually decreases with the formation of CB. Further, C ions are predominantly conducted in an amorphous phase matrix with higher room temperature ionic conductivity.

A preparation method for a solid electrolyte, including the following steps: in an anhydrous and oxygen-free inert atmosphere, mixing CₐN_{b} and MB_{y} according to a stoichiometric ratio by a mechanical ball milling method to make a solid-phase reaction to obtain the solid electrolyte (CₐN_{b})_{X}_{^{−}}MB_{y}.

Control parameters of the mechanical ball milling method include: a diameter of ball milling beads of 3 mm to 10 mm; a total mass ratio of the ball milling beads to raw materials of 60:1 to 20:1; a ball milling time of 1 h to 30 h; a rotation speed of a ball mill of 400 r/min to 800 r/min. During mechanical ball milling, a ball milling tank is effectively cooled to prevent excessive tank temperatures. Preferably, a circulating water cooling mode is employed.

In some embodiments of the present disclosure, the anhydrous and oxygen-free inert atmosphere is N₂ or Ar gas; preferably, Ar gas is employed.

In some embodiments of the present disclosure, the diameter of the ball milling beads is 3 mm to 10 mm; in specific embodiments, the diameter of the ball milling beads is 3 mm, 4 mm, 5 mm, 6 mm, 7 mm, 8 mm, 9 mm, or 10 mm.

In some embodiments of the present disclosure, a pellet ratio is 60:1 to 20:1; in specific embodiments, the pellet ratio is 60:1, 50:1, 40:1, 30:1, or 20:1, etc.

In some embodiments of the present disclosure, the ball milling time is 1 h to 30 h; in specific embodiments, the ball milling time is 1 h, 2 h, 3 h, 4 h, 5 h, 6 h, 7 h, 8 h, 9 h, 10 h, 20 h, or 30 h, etc.

In some embodiments of the present disclosure, the rotation speed of the ball mill is 400 r/min to 800 r/min; in specific embodiments, the rotation speed of the ball mill is 400 r/min, 500 r/min, 600 r/min, 700 r/min, or 800 r/min, etc.

It should be noted that too long ball milling time or too high ball milling rotation speed may result in the formation of a CB crystal phase and a decrease in ionic conductivity; by adjusting the ball milling parameters, a solid electrolyte with the highest ionic conductivity or an electronically insulating and air-stable solid electrolyte containing a small quantity of nanocrystals can be obtained.

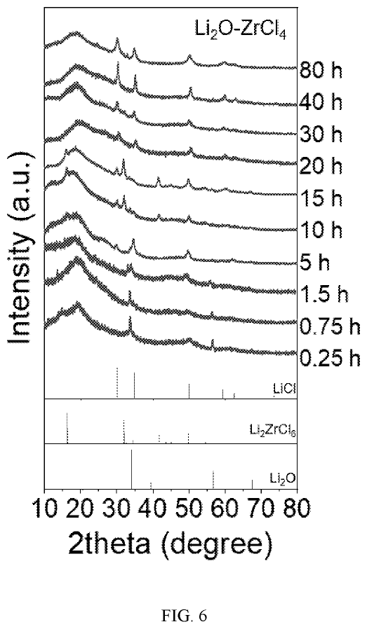

The relative proportions of amorphous phases and crystalline phases and the compositions of the crystalline phases in the solid electrolyte prepared by the above solution are controlled by synthesis conditions, including ball milling parameters (ball milling time and rotation speed), raw material ratios, annealing conditions, etc. During the ball milling process, the residual raw material crystal phases are reduced until disappearance with the appearance of CₑMB_{f} nanocrystals. The M content in a crystalline phase CₑMB_{f} gradually decreases and eventually evolves into CB. The composition and ionic conductivity of the amorphous solid solution type electrolyte can be controlled by optimizing the ball milling parameters; in the process of preparing Li₂O—ZrCl₄ through ball milling, when the ball milling rotation speed is 600 rpm and the ball milling time is 20 h, the crystalline phase of the resulting product is less, and the ionic conductivity is the highest at 3.0×10³ Scm⁻¹. When the ball milling time is 15 h, the crystal phase of the resulting product is Li₂ZrCl₆; when the ball milling time is 80 h, the crystalline phase of the resulting product is LiCl. For example, in the process of preparing Li₂O—ZrCl₄ through ball milling, the crystal phase gradually evolves from Li₂O to Li₂ZrCl₆ and finally becomes LiCl, and the X-ray diffraction pattern evolves as shown in FIG. 6. Due to the larger electronic bandgap and lower electronic conductivity of the nanocrystals with high Li content and low Zr content, the reactivity with water molecules in humid air is weaker (better in air stability). Thus, by controlling the ratio and composition of the nanocrystals, the air stability and grain boundary electronic conductivity after cold pressing molding of powder can be optimized.

In some embodiments, the battery is an all-solid-state battery including a positive electrode sheet, a negative electrode sheet, and a solid electrolyte sheet between the positive electrode sheet and the negative electrode sheet. The solid electrolyte sheet is obtained from a solid electrolyte subjected to cold pressing. The solid electrolyte is the solid electrolyte described above or the solid electrolyte prepared by the preparation method for the solid electrolyte described above.

In some embodiments, kinds of batteries include lithium-ion batteries, sodium-ion batteries, potassium-ion batteries, silver-ion batteries, or copper-ion batteries.

In some embodiments, the positive electrode sheet is obtained by cold pressing or coating of a positive electrode active substance and a positive electrode filler. The positive electrode active substance includes, but is not limited to, at least one of cobalt-aluminum oxide, lithium iron phosphate, lithium-rich phase lithium manganese oxide, lithiated layered oxide, and lithiated layered sulfide, and at least one of sodiumated layered oxide, a polyanion compound, and a Prussian blue-based compound. The positive electrode filler is at least one of an ion conducting agent, a conductive agent, and a binder; the ion-conducting agent is the same material as the solid electrolyte between the positive electrode sheet and the negative electrode sheet of the battery; the conductive agent may include at least one of graphite, carbon black, acetylene black, Ketjen black, and carbon fiber; the binder may include, for example, at least one of butadiene styrene rubber, polytetrafluoroethylene, polyvinylidene fluoride, and polyethylene. Cold pressing or coating methods are common methods in the art for preparing the positive electrode sheet.

The negative electrode sheet is obtained by cold pressing or coating of a negative electrode active substance and a negative electrode filler. The negative electrode active substance refers to materials capable of storing and releasing Li⁺ or Na⁺ ions, including but not limited to metallic materials, graphite, silicon; the metallic material may be an elemental metal or an alloy; when the metal material is used as the negative electrode active substance, a negative electrode filler may not be used. The negative electrode filler is at least one of an ion conducting agent, a conductive agent, and a binder; the ion-conducting agent is the same material as the solid electrolyte between the positive electrode sheet and the negative electrode sheet of the battery; the conductive agent may include at least one of graphite, carbon black, acetylene black, Ketjen black, and carbon fiber; the binder may include, for example, at least one of butadiene styrene rubber, polytetrafluoroethylene, polyvinylidene fluoride, and polyethylene. Cold pressing or coating methods are common methods in the art for preparing the negative electrode sheet.

This is further illustrated below with reference to specific embodiments.

### Embodiment 1

This embodiment provides a solid electrolyte Li₂O—ZrCl₄, and a specific preparation method is shown below:

In an anhydrous and oxygen-free argon atmosphere glove box, Li₂O and ZrCl₄ are mixed in a ratio of 1:1 of amounts of substances, and subjected to manual grinding using an agate mortar for 10 min to mix well.

Mixed powder (2 g) is transferred to a 75 mL ball milling tank, and 60 g of milling beads with a diameter of 3 mm are added accordingly, after which the ball milling tank is vacuumized and sealed. Ball milling is carried out on a planetary ball mill at a rotation speed of 550 revolutions/min for 20 h, and circulating water is used for cooling the ball milling tank during ball milling. After the ball milling is completed, the ball milling tank is transferred to a glove box and opened, and the powder in the tank is removed, which is a synthesized Li₂O—ZrCl₄ solid electrolyte.

Following the above steps, the solid electrolytes of Embodiment to Embodiment 37 are synthesized respectively, except that raw materials and preparation processes are adaptively adjusted, as shown in Table 1;

Table 1 shows data of raw materials and reaction conditions for preparation of solid electrolytes by different substances of Embodiment 1 to Embodiment 34;

| | | | | Ratio of | Mass of | Mass of | | |
|---|---|---|---|---|---|---|---|---|
| | | Raw | Raw | amounts | mixed | grinding | Rotation | Ball |
| | Solid | material | material | of | powder | beads | speed | milling |
| Embodiment | electrolyte | I | II | substances | g | g | r/min | time h |
| Embodiment 1 | Li₂O—ZrCl₄ | Li₂O | ZrCl₄ | 1:1 | 2 | 60 | 550 | 20 |
| Embodiment 2 | Li₂S—ZrCl₄ | Li₂S | ZrCl₄ | 1:1 | 2 | 60 | 550 | 20 |
| Embodiment 3 | Li₃N—ZrCl₄ | Li₃N | ZrCl₄ | 1:1 | 2 | 60 | 550 | 20 |
| Embodiment 4 | Na₂S—ZrCl₄ | Na₂S | ZrCl₄ | 1:1 | 2 | 60 | 550 | 20 |
| Embodiment 5 | Ag₂O—ZrCl₄ | Ag₂O | ZrCl₄ | 1:1 | 2 | 60 | 550 | 20 |
| Embodiment 6 | Li₂SO₄—ZrCl₄ | Li₂SO₄ | ZrCl₄ | 1:1 | 1 | 40 | 600 | 1.5 |
| Embodiment 7 | Li₃PO₄—ZrCl₄ | Li₃PO₄ | ZrCl₄ | 1:1 | 1 | 40 | 600 | 1.5 |
| Embodiment 8 | Li₂CO₃—ZrCl₄ | Li₂CO₃ | ZrCl₄ | 1:1 | 1 | 40 | 600 | 1.5 |
| Embodiment 9 | LiHCO₃—ZrCl₄ | LiHCO₃ | ZrCl₄ | 1:1 | 1 | 40 | 600 | 1.5 |
| Embodiment 10 | Li₂C₂O₄—ZrCl₄ | Li₂C₂O₄ | ZrCl₄ | 1:1 | 1 | 40 | 600 | 1.5 |
| Embodiment 11 | 0.5Li₄P₂O₇—ZrCl₄ | Li₄P₂O₇ | ZrCl₄ | 0.5:1 | 1 | 40 | 600 | 3 |
| Embodiment 12 | Li₂O—HfCl₄ | Li₂O | HfCl₄ | 1:1 | 2 | 60 | 550 | 20 |
| Embodiment 13 | Li₂S—HfCl₄ | Li₂S | HfCl₄ | 1:1 | 2 | 60 | 550 | 20 |
| Embodiment 14 | Li₃N—HfCl₄ | Li₃N | HfCl₄ | 1:1 | 2 | 60 | 550 | 20 |
| Embodiment 15 | Li₂SO₄—HfCl₄ | Li₂SO₄ | HfCl₄ | 1:1 | 1 | 40 | 600 | 1.5 |
| Embodiment 16 | 2/3Li₃PO₄—HfCl₄ | Li₃PO₄ | HfCl₄ | 2/3:1 | 1 | 40 | 600 | 1.5 |
| Embodiment 17 | Li₂S—TaCl₅ | Li₂S | TaCl₅ | 1:1 | 1 | 40 | 600 | 3 |
| Embodiment 18 | Ag₂S—TaCl₅ | Ag₂S | TaCl₅ | 1:1 | 1 | 40 | 600 | 3 |
| Embodiment 19 | Na₂S—TaCl₅ | Na₂S | TaCl₅ | 1:1 | 1 | 40 | 600 | 3 |
| Embodiment 20 | Li₂SO₄—TaCl₅ | Li₂SO₄ | TaCl₅ | 1:1 | 1 | 40 | 600 | 1 |
| Embodiment 21 | Li₃PO₄—TaCl₅ | Li₃PO₄ | TaCl₅ | 1:1 | 1 | 40 | 600 | 1 |
| Embodiment 22 | 2/3Li₃PO₄—TaCl₅ | Li₃PO₄ | TaCl₅ | 2/3:1 | 1 | 40 | 600 | 1 |
| Embodiment 23 | Li₂CO₃—TaCl₅ | Li₂CO₃ | TaCl₅ | 1:1 | 1 | 40 | 600 | 1 |
| Embodiment 24 | Li₃PO₄—SiI₄ | Li₃PO₄ | SiI₄ | 1:1 | 1 | 40 | 600 | 1 |
| Embodiment 25 | Li₂CO₃—AlCl₃ | Li₂CO₃ | AlCl₃ | 1:1 | 1 | 40 | 600 | 20 |
| Embodiment 26 | 0.5Li₄SiO₄—NbCl₅ | Li₄SiO₄— | NbCl₅ | 0.5:1 | 1 | 40 | 600 | 20 |
| Embodiment 27 | 0.5Li₂CO₃—NbOCl₃ | Li₂CO₃ | NbOCl₃ | 0.5:1 | 1 | 40 | 600 | 20 |
| Embodiment 28 | 0.5Li₂CO₃—AlOCl | Li₂CO₃ | AlOCl | 0.5:1 | 1 | 40 | 600 | 20 |
| Embodiment 29 | Li₃PO₄—TaF₅ | Li₃PO₄ | TaF₅ | 1:1 | 1 | 40 | 600 | 3 |
| Embodiment 30 | Li₂CO₃—HfCl₄ | Li₂CO₃ | HfCl₄ | 1:1 | 1 | 40 | 600 | 1.5 |
| Embodiment 31 | 0.5Li₂CO₃—HfCl₄ | Li₂CO₃ | HfCl₄ | 0.5:1 | 1 | 40 | 600 | 1.5 |
| Embodiment 32 | 0.8Li₂CO₃—HfCl₄ | Li₂CO₃ | HfCl₄ | 0.8:1 | 1 | 40 | 600 | 1.5 |
| Embodiment 33 | Li₂O—AlCl₃ | Li₂O | AlCl₃ | 1:1 | 1 | 40 | 600 | 20 |
| Embodiment 34 | LiZrCl₅ | LiCl | ZrCl₄ | 1:1 | 1 | 40 | 600 | 20 |

### Embodiment 35

The present embodiment provides a solid electrolyte (Li₃PO₄)_{2/3}(AlCl₃)_{1/5}(ZrCl₄)_{1/5}(HfCl₄)_{1/5}(TaCl₅)_{1/5}(NbCl₅)_{1/5}. The preparation method provided in Embodiment 1 is specifically followed, except that raw materials and amounts of substances thereof are replaced in the manner that Li₃PO₄, AlCl₃, ZrCl₄, HfCl₄, TaCl₅, NbCl₅ are mixed in a ratio of amounts of substances of 2/3:1/5:1/5:1/5:1/5:1/5, the mass of the mixed powder is 40 g, and the ball milling time is 2 h;

### Embodiment 36

The present embodiment provides a solid electrolyte (Li₃PO₄)(InCl₃)_{0.2}ZrCl₄. The preparation method provided in Embodiment 1 is specifically followed, except that the raw materials and amounts of substances thereof are replaced in the manner that Li₃PO₄, InCl₃, ZrCl₄ are mixed in a ratio of amounts of substances of 1:0.2:1, the mass of the mixed powder is 40 g, and the ball milling time is 3 h;

### Embodiment 37

The present embodiment provides a solid electrolyte (Li₂CO₃)_{1/3}(Li₃PO₄)_{1/3}(Li₂SO₄)_{1/3}—HfCl₄. The preparation method provided in Embodiment 1 is specifically followed, except that the raw materials and amounts of substances thereof are replaced in the manner that Li₂CO₃, Li₃PO₄, Li₂SO₄ and HfCl₄ are mixed in a ratio of amounts of the substances 1/3:1/3:1/3:1.

### Comparative Example 1

The present comparative example provides a solid electrolyte, and a specific preparation method is shown below:

In an anhydrous and oxygen-free argon atmosphere glove box, LiCl and ZrCl₄ are mixed in a ratio of 2:1 of amounts of substances, and subjected to manual grinding using an agate mortar for 10 min to mix well.

Mixed powder (about 2 g) is transferred to a 75 mL ball milling tank, and 60 g of milling beads with a diameter of 3 mm are added accordingly, after which the ball milling tank is vacuumized and sealed. Ball milling is carried out on a planetary ball mill at a rotation speed of 550 revolutions/min for 20 h, and circulating water is used for cooling the ball milling tank during ball milling. After the ball milling is completed, the ball milling tank is transferred to a glove box and opened, and the powder in the tank is removed, which is a synthesized Li₂ZrCl₆ halide solid electrolyte.

### Application Example 1

The present embodiment provides an all-solid-state lithium battery assembled using the solid electrolyte (Li₂SO₄)ZrCl₄ provided in Embodiment 6, and a specific assembly process is shown below:
Step 1: Commercially available lithiated layered oxide LiNi_{0.88}Co_{0.09}Mn_{0.03}O₂ (as a positive electrode active substance), (Li₂SO₄)ZrCl₄ (as an ion conducting agent), and carbon black (as an electron conducting agent) in a mass ratio of 7:3:0.1 are weighed and manually ground in a mortar for 10 min to homogeneously mix to form a composite positive electrode.
Step 2: 50 mg of solid electrolyte Li₂SO₄—ZrCl₄ powder synthesized in Embodiment 6 is weighed and cold-pressed into a solid electrolyte sheet having a diameter of 10 mm at an intensity of pressure of 100 MPa and a dwell pressure of 2 min. 50 mg of Li₆PS₅Cl is weighed as a barrier layer between the solid electrolyte Li₂SO₄—ZrCl₄ and the negative electrode of LiIn, spread evenly on the surface of one side of the Li₂SO₄—ZrCl₄ solid electrolyte sheet, and cold-pressed at an intensity of pressure of 100 MPa and a dwell pressure of 2 min.
Step 3: 10 mg of composite positive electrode prepared in Step 1 is weighed, spread evenly on the surface of the other side of the (Li₂SO₄)ZrCl₄ solid electrolyte sheet prepared in Step 2, and cold-pressed at an intensity of pressure of 350 MPa and a dwell pressure 2 min.
Step 4: A commercially available indium sheet (10 mm in diameter and 200 μm in thickness) is used as a negative electrode active substance and attached to the surface of the other side of a Li₆PS₅Cl barrier layer prepared in Step 2 to form “electrolyte sheet-barrier layer-negative electrode sheet”, a pressure of 100 MPa is applied, and an all-solid-state lithium battery is obtained after assembly is completed.

The Step 1 to Step 4 are all performed in an anhydrous and oxygen-free argon atmosphere glove box.

### Application Example 2

All-solid-state LiIn—LiNi_{0.88}Co_{0.09}Mn_{0.03}O₂(LiIn-NMC88) batteries are assembled using the method provided in Application Example 1, with the difference that the solid electrolyte used is the Li₃PO₄—TaCl₅ solid electrolyte synthesized in Embodiment 21.

### Application Example 3

An all-solid-state LiIn—LiCoO₂ battery is assembled using the method provided in Application Example 1, with the difference that the positive electrode active substance is changed from LiNi_{0.88}Co_{0.09}Mn_{0.03}O₂ to LiCoO₂. The solid electrolyte used is the (Li₃PO₄)ZrCl₄ solid electrolyte synthesized in Embodiment 7.

The substances obtained in the embodiments and the corresponding properties are analyzed below.

### I. Characterization Analysis

### 1. Ionic Conductivity Characterization Analysis

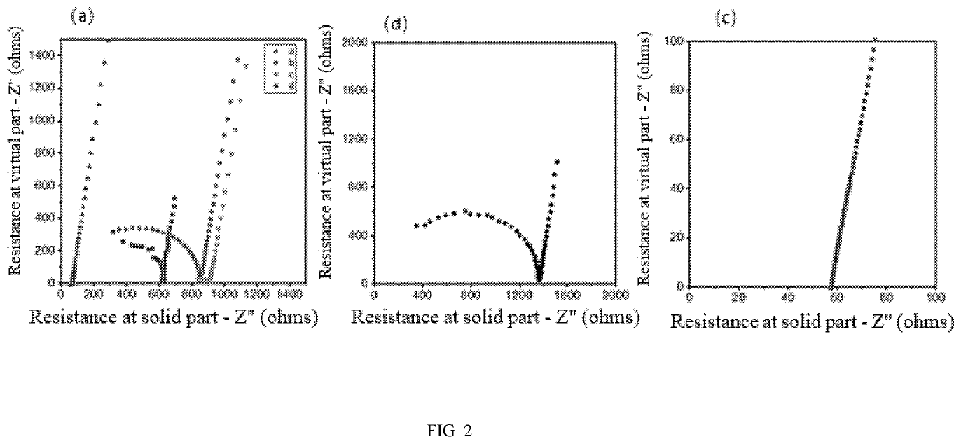

(1) Characterization Method: In an anhydrous and oxygen-free argon atmosphere glove box, the solid electrolytes prepared in Embodiment 1 to Embodiment 37 and Comparative Example 1 are filled into a cylindrical tableting mold (10 mm in diameter); and cold-pressed at an intensity of pressure of 375 MPa for 2 min to obtain a solid electrolyte sheet having a thickness of 0.5 mm to 1.5 mm and a diameter of 10 mm; after the upper and lower surfaces of the solid electrolyte sheet are plated with gold, two stainless steel blocking electrodes are used to sandwich the upper and lower surfaces, an electrochemical workstation is connected, and electrochemical alternating current impedance spectra are measured at room temperature; the room temperature ionic conductivity is extracted from the measured electrochemical impedance spectra, and the corresponding ionic conductivity is obtained from the electrochemical alternating-current impedance spectra as characterized in FIG. 2, as shown in Table 2.

(2) Characterization Results: The ionic conductivities of the carrier salts CₐA_{b} are all less than 10⁻⁷ S cm⁻¹, and the ionic conductivities of the solid electrolytes prepared after mixing with the van der Waals crystals MB_{y} are all greater than 10⁻³ S cm⁻¹. Table 2 shows the ionic conductivities of the solid electrolytes synthesized in Embodiment 1 to Embodiment 37, Comparative Example 1, and comparative samples.

TABLE 2
Ionic conductivities of solid electrolytes

| | | Ionic |
|---|---|---|
| | | conductivity |
| Embodiment | Solid electrolyte | S · cm⁻¹ |
| Comparative | Li₂ZrCl₆ | 0.3 × 10⁻³ |
| Example 1 | | |
| Comparative | Li₂O | <10⁻⁷ |
| Sample | | |
| Comparative | Li₂CO₃ | <10⁻⁸ |
| Sample | | |
| Comparative | Li₃PO₄ | <10⁻⁷ |
| Sample | | |
| Comparative | Li₂SO₄ | <10⁻⁷ |
| Sample | | |
| Embodiment 1 | Li₂O—ZrCl₄ | 3.0 × 10⁻³ |
| Embodiment 2 | Li₂S—ZrCl₄ | 1.2 × 10⁻³ |
| Embodiment 3 | Li₃N—ZrCl₄ | 0.6 × 10⁻³ |
| Embodiment 4 | Na₂S—ZrCl₄ | 0.5 × 10⁻³ |
| Embodiment 5 | Ag₂O—ZrCl₄ | 2.9 × 10⁻³ |
| Embodiment 6 | Li₂SO₄—ZrCl₄ | 1.59 × 10⁻³ |
| Embodiment 7 | Li₃PO₄—ZrCl₄ | 2.94 × 10⁻³ |
| Embodiment 8 | Li₂CO₃—ZrCl₄ | 2.55 × 10⁻³ |
| Embodiment 9 | LiHCO₃—ZrCl₄ | 1.23 × 10⁻³ |
| Embodiment 10 | Li₂C₂O₄—ZrCl₄ | 0.4 × 10⁻³ |
| Embodiment 11 | 0.5Li₄P₂O₇—ZrCl₄ | 0.73 × 10⁻³ |
| Embodiment 12 | Li₂O—HfCl₄ | 2.5 × 10⁻³ |
| Embodiment 13 | Li₂S—HfCl₄ | 1.4 × 10⁻³ |
| Embodiment 14 | Li₃N—HfCl₄ | 0.3 × 10⁻³ |
| Embodiment 15 | Li₂SO₄—HfCl₄ | 1.18 × 10⁻³ |
| Embodiment 16 | 2/3Li₃PO₄—HfCl₄ | 2.5 × 10⁻³ |
| Embodiment 17 | Li₂S—TaCl₅ | 2.45 × 10⁻³ |
| Embodiment 18 | Ag₂S—TaCl₅ | 4.95 × 10⁻³ |
| Embodiment 19 | Na₂S—TaCl₅ | 1.03 × 10⁻³ |
| Embodiment 20 | Li₂SO₄—TaCl₅ | 1.23 × 10⁻³ |
| Embodiment 21 | Li₃PO₄—TaCl₅ | 6.71 × 10⁻³ |
| Embodiment 22 | 2/3Li₃PO₄—TaCl₅ | 10.72 × 10⁻³ |
| Embodiment 23 | Li₂CO₃—TaCl₅ | 5.31 × 10⁻³ |
| Embodiment 24 | Li₃PO₄—SiI₄ | 6.71 × 10⁻³ |
| Embodiment 25 | Li₂CO₃—AlCl₃ | 0.47 × 10⁻³ |
| Embodiment 26 | 0.5Li₄SiO₄—NbCl₅ | 0.8 × 10⁻³ |
| Embodiment 27 | 0.5Li₂CO₃—NbOCl₃ | 1.2 × 10⁻³ |
| Embodiment 28 | 0.5Li₂CO₃—AlOCl | 0.3 × 10⁻³ |
| Embodiment 29 | Li₃PO₄—TaF₅ | 8.15 × 10⁻⁶ |
| Embodiment 30 | Li₂CO₃—HfCl₄ | 2.86 × 10⁻³ |
| Embodiment 31 | 0.5Li₂CO₃—HfCl₄ | 2.1 × 10⁻³ |
| Embodiment 32 | 0.8Li₂CO₃—HfCl₄ | 2.4 × 10⁻³ |
| Embodiment 33 | Li₂O—AlCl₃ | 0.82 × 10⁻³ |
| Embodiment 34 | LiZrCl₅ | 0.60 × 10⁻³ |
| Embodiment 35 | (Li₃PO₄)_{2/3}(AlCl₃)_{1/5}(ZrCl₄)_{1/5}(HfCl₄)_{1/5}(TaCl₅)_{1/5}(NbCl₅)_{1/5} | 2.76 × 10⁻³ |
| Embodiment 36 | (Li₃PO₄)(InCl₃)_{0.2}ZrCl₄₍ | 2.56 × 10⁻³ |
| Embodiment 37 | (Li₂CO₃)1/3(Li₃PO₄)1/3(Li₂SO₄)1/3—HfCl₄ | ×10⁻³ |

### 2. Local Structure Analysis

(1) Characterization Method: The solid electrolytes synthesized in the embodiments are characterized using Fourier transform infrared spectroscopy, X-ray absorption spectroscopy, and pair distribution functions.

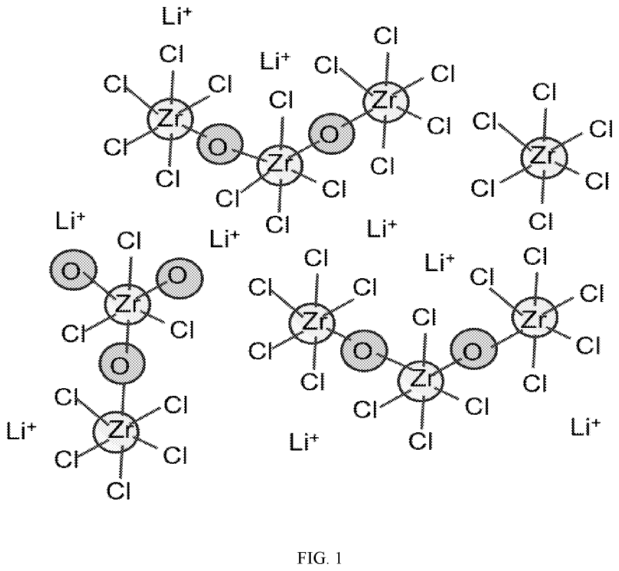

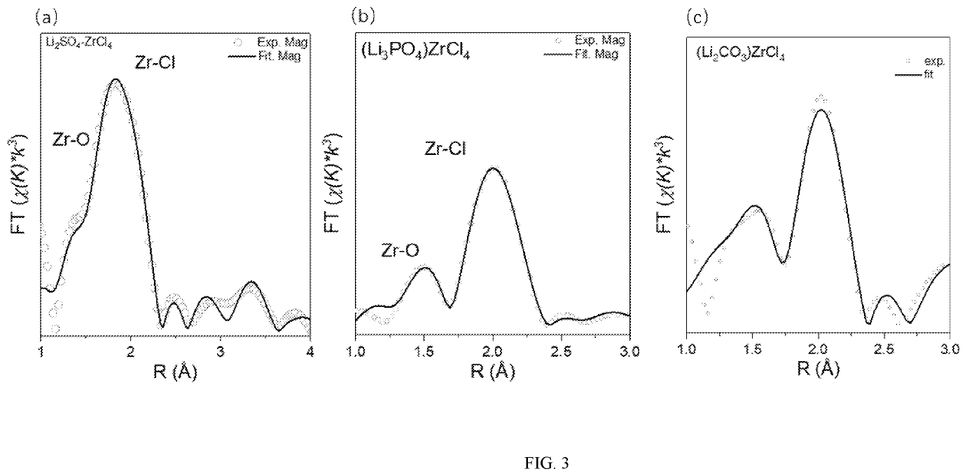

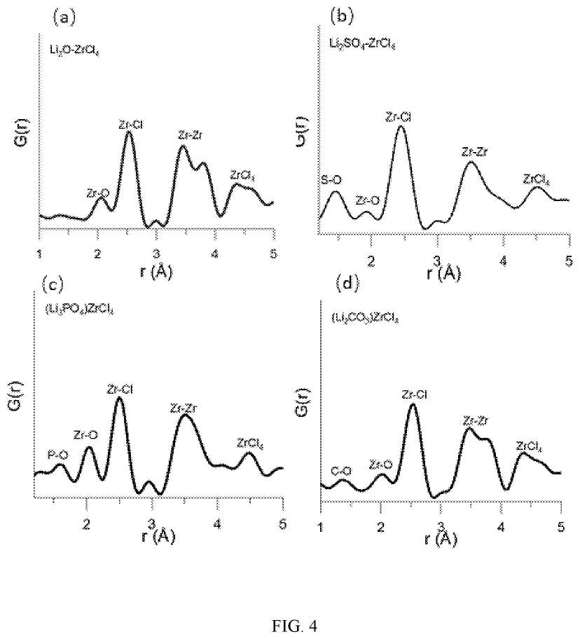

(2) Characterization Results: As shown in FIG. 3(b), 582 cm⁻¹ and 1010 cm⁻¹ correspond to bending vibration of P—O and asymmetric stretching of PO₄³⁻ anions, respectively. These peaks are still present in the (Li₃PO₄)ZrCl₄ solid electrolyte, demonstrating the presence of PO₄³⁻; the shift of these peaks to higher wave numbers demonstrates the coordination of PO₄³⁻ and Zr. The formation of the Zr—O—P structure is also demonstrated by the generation of a new peak at 700 cm⁻¹ to 800 cm⁻¹. FIG. 4(c) is a pair distribution function of the (Li₃PO₄)ZrCl₄ solid electrolyte, FIG. 3(b) is an X-ray absorption spectrum of the (Li₃PO₄)ZrCl₄ solid electrolyte, through the local structure analysis, it can be determined that the local structure is: Cl in ZrCl₆ octahedrons are is partially replaced by O, a plurality of ZrCl₆ polyhedrons are linked by multiple O of PO₄ tetrahedrons, such a local structure constitutes an open framework structure, which has a cross-linked network framework and through three-dimensional channels, and vacancies therein are filled with Li ions; FIG. 4(d) is a pair distribution function of the (Li₂CO₃)ZrCl₄ solid electrolyte, FIG. 3(c) is an X-ray absorption spectrum of the (Li₂CO₃)ZrCl₄ solid electrolyte, through the local area structure analysis, it can be determined that the local structure is: Cl in ZrCl₆ octahedrons is partially replaced by O, a plurality of ZrCl₆ polyhedrons are linked by a plurality of O of CO₃ planar triangles, such a local structure constitutes an open framework structure, which has a cross-linked network framework and through three-dimensional channels, and vacancies therein are filled with Li ions. FIG. 4(b) is a pair distribution function of the Li₂SO₄—ZrCl₄ solid electrolyte, FIG. 3(a) is an X-ray absorption spectrum of the Li₂SO₄—ZrCl₄ solid electrolyte, through the local structure analysis, it can be determined that the local structure is: Cl in [ZrCl₆] octahedrons is partially replaced by O, a plurality of ZrCl₆ polyhedrons are linked by a plurality of O of SO₄ tetrahedrons, such a local structure constitutes an open framework structure, which has a cross-linked network framework and through three-dimensional channels, and vacancies therein are filled with Li ions. FIG. 4(a) is a pair distribution function of a Li₂O—ZrCl₄ solid electrolyte. Through the local structure analysis, it can be determined that the local structure is: the Cl in the [ZrCl₆] octahedrons is partially replaced by O, and a plurality of [ZrCl₆] polyhedrons are linked by O, as shown in FIG. 1.

### 3. Crystal Structure Characterization Analysis

(1) Characterization Method: The solid electrolytes prepared in embodiments are characterized using an X-ray diffractometer.

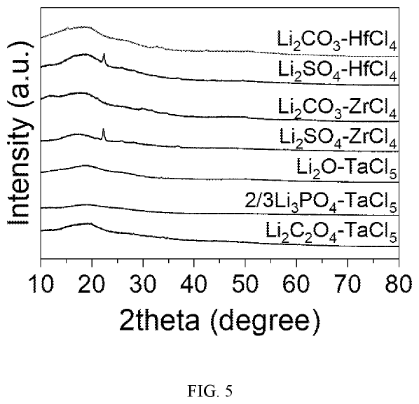

(2) Characterization Results: Shown in FIG. 5 are X-ray diffraction spectra of solid electrolyte Li₂CO₃—HfCl₄, Li₂SO₄—HfCl₄, Li₂CO₃—ZrCl₄, Li₂SO₄—ZrCl₄, Li₂O—TaCl₅, ⅔Li₃PO₄—ZrCl₄, Li₂C₂O₄—TaCl₅ lithium salt-van der Waals crystals, respectively. It is shown through the results that none of the 7 solid electrolytes show significant diffraction peaks, indicating that the 7 solid electrolytes described above are disordered amorphous phases.

Shown in FIG. 6 is the evolution of the crystal structure of the Li₂O—ZrCl₄ solid electrolyte over the ball milling time, the diffraction peaks are broader and the strength is less throughout the ball milling process, indicating that the Li₂O—ZrCl₄ electrolyte is a material with a majority of amorphous bodies and few nanocrystals. The change in nanocrystals is that the raw material Li₂O phase gradually disappears, then the Li₂ZrCl₆ crystalline phase appears, and finally it becomes LiCl. Comparative Example 1 provides a Li₂ZrCl₆ halide solid electrolyte having a distinct diffraction peak, and the diffraction peak can be demarcated as Li₂ZrCl₆ (space group P-3 ml), indicating that the halide solid electrolyte is a crystalline phase Li₂ZrCl₆.

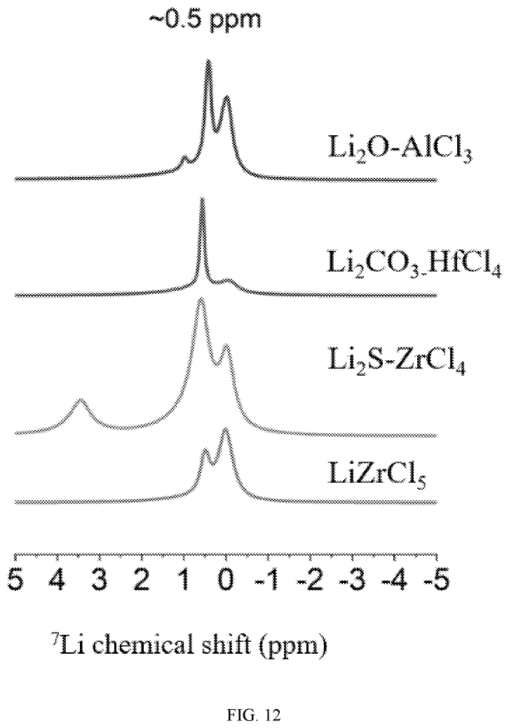

FIG. 12 characterizes ⁷Li solid nuclear magnetic spectra of the four solid electrolytes Li₂O—AlCl₃, Li₂CO₃—HfCl₄, LiZrCl₅, Li₂S—ZrCl₄ prepared in Embodiments 33, 30, 34 and 2. The results show that the four solid electrolytes provided have a peak around 0.5 ppm, and the peak corresponds to an amorphous phase in the solid electrolytes. In addition to the peak, other peaks may refer to residual raw materials or precipitated LiCl. When C is Li, the solid electrolyte is an amorphous or near-amorphous structure, a coordination number of Li⁺ ranges from 3 to 5; a coordination number of the Li⁺ ranging from 3 to 5 means that in the solid state nuclear magnetic ⁷Li spectrum, and the solid electrolytes have characteristic peaks at 0.4 ppm to 0.6 ppm;

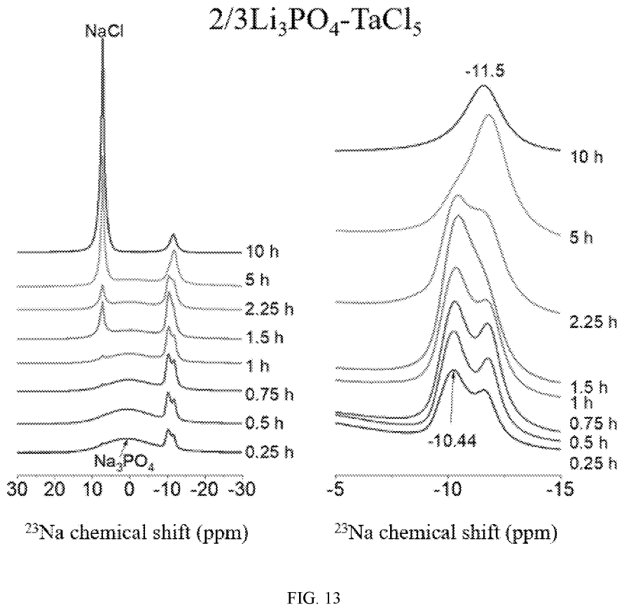

FIG. 13 characterizes the ²³Na solid nuclear magnetic spectrum of the ⅔Li₃PO₄—TaCl₅ solid electrolyte in Embodiment 22 with reference to 1 mol/L NaCl aqueous solution at 0 ppm. The results show that the sodium environment of this material consists of a combination of three ²³Na chemical shifts, which are located around 7.2 ppm, −10.4 ppm, and −11.5 ppm, respectively. The ionic conductivity increases with an increase of −11 ppm signals, with the peak of Na⁺ shifted from −10.44 ppm to −11.5 ppm of a high field. It can be seen that the sodium environment of −11 ppm dominates Na⁺ conduction. It indicates that when C is Na, the solid electrolyte is an amorphous or near-amorphous structure, and a coordination number of Na⁺ ranges from 7 to 9; the coordination number of the Na⁺ ranging from 7 to 9 means that in the solid state nuclear magnetic ²³Na spectrum, and the solid electrolytes have characteristic peaks around −11 ppm.

### 4. Microscopic Structure Characterization Analysis

(1) Characterization Method: The high-resolution cryo-transmission electron microscopy is used for characterizing a microscopic structure of the synthesized Li₂O—ZrCl₄ solid electrolyte.

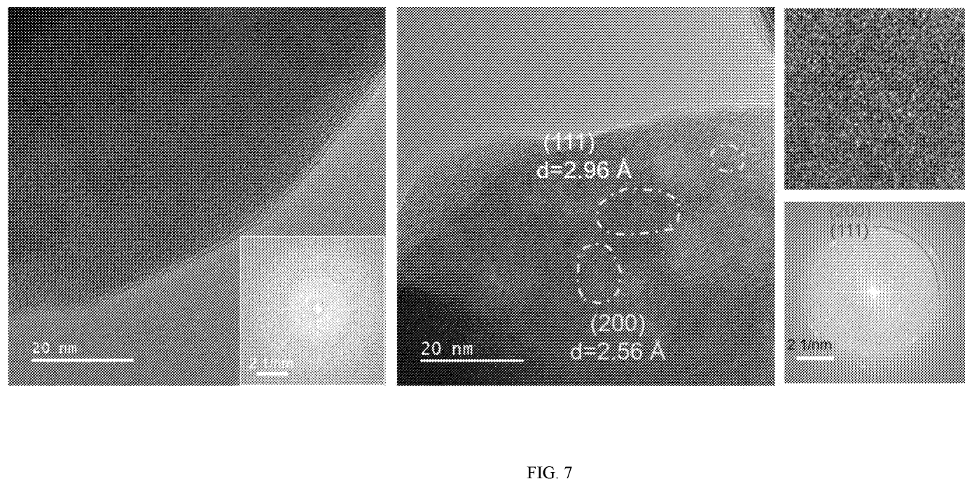

(2) Characterization Results: The characterization results are shown in FIG. 7, and the results show that most of the Li₂O—ZrCl₄ solid electrolytes are disordered amorphous phases, the crystalline phase is LiCl, and the grain size is about 10 nm. In addition, the crystalline phase is enriched on the surfaces of the particles.

Crystal structure characterization analysis and microscopic structure characterization analysis show that lithium salts having different anions make a solid-phase reaction with van der Waals crystals to obtain materials with similar crystal structures and microscopic structures, and ionic conductivity is achieved. This solid-phase reaction behavior is similar to the dissociation behavior of salts in solutions, which can be understood as the dissociation behavior of lithium salts (solutes) in van der Waals crystals (solid solvents).

### II. Electrochemical Performance Test

### 1. Electrochemical Window Test

(1) Test Method: A battery configured as a solid electrolyte+carbon black (a mass ratio of 5:5) solid electrolyte |Li₆PS₅Cl|Li is subjected to a linear scan method test using an EC-lab electrochemical workstation at normal temperature.

The solid electrolytes are synthesized Li₂O—ZrCl₄, Li₃PO₄—ZrCl₄, and Li₂ZrCl₆ synthesized in Comparative Example 1, respectively.

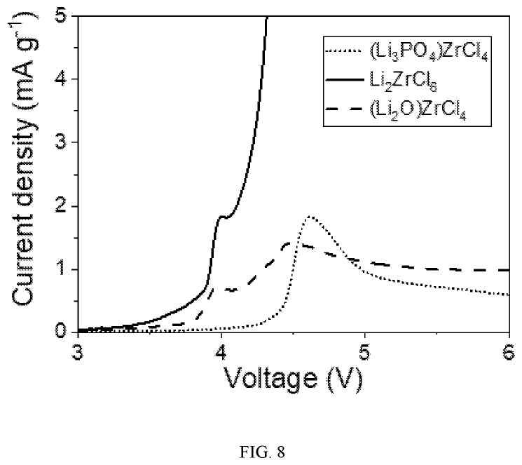

(2) Test Results: As shown in FIG. 8, an oxidation limit of Li₃PO₄—ZrCl₄ is 4.3 V, which is greater than an oxidation limit of Li₂ZrCl₆ of 3.75 V and an oxidation limit of Li₂O—ZrCl₄ of 3.85 V in Comparative Example 1.

### 2. Galvanostatic Charge-Discharge Test

(1) Test method: The all-solid-state battery provided in Application Example 1 is subjected to a galvanostatic charge-discharge test using a blue battery test system at normal temperature, a voltage range is 2.5 V to 4.3 V (a voltage relative to Li⁺/Li), cycling for the first 3 weeks adopts 0.1 C rate for activation, and cycling for the 4th week adopts 2 C rate.

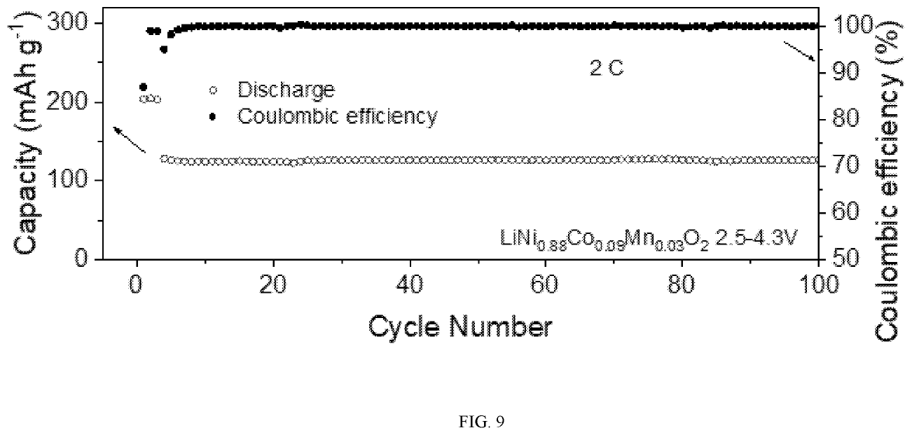

(2) Test Results: The test results are as shown in FIG. 9. Application Example 1 provides an all-solid-state battery, the all-solid-state battery has a reversible capacity of 127 mAh g⁻¹ after 100 cycles at 2 C rate, and the capacity is almost undiminished.

### 3. Fast Charge Performance Test

(1) Test Method: The all-solid-state battery provided in Application Example 2 is subjected to a cycle performance test using a blue battery test system at normal temperature, a voltage range is 2.5 V to 4.3 V (a voltage relative to Li⁺/Li), and a cycle rate is 5 C.

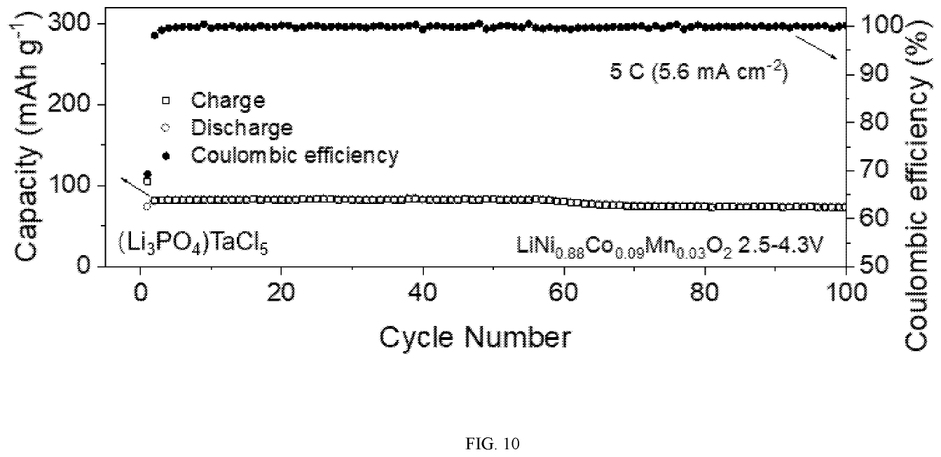

(2) Test Results: A graph of specific capacity-cycle number for the first 100 weeks of cycles is shown as FIG. 10, and the results show that the reversible capacity for the first week of cycling (5 C rate) is about 81.6 mAh g⁻¹, and after 100 weeks of cycling, the capacity is almost undiminished. The battery performance results of FIG. 13 demonstrate that the all-solid-state lithium battery assembled using the (Li₃PO₄)TaCl₅ solid electrolyte has excellent high capacity and cycling stability at room temperature.

### 4. Low-temperature Service Performance Test

(1) Test Method: The all-solid-state battery provided in Application Example 3 is subjected to a galvanostatic charge-discharge test at low temperature (−30° C.) using a blue battery test system, a voltage range is 2.5 V to 4.6 V (a voltage relative to Li⁺/Li), and a cycle rate is 0.1 C.

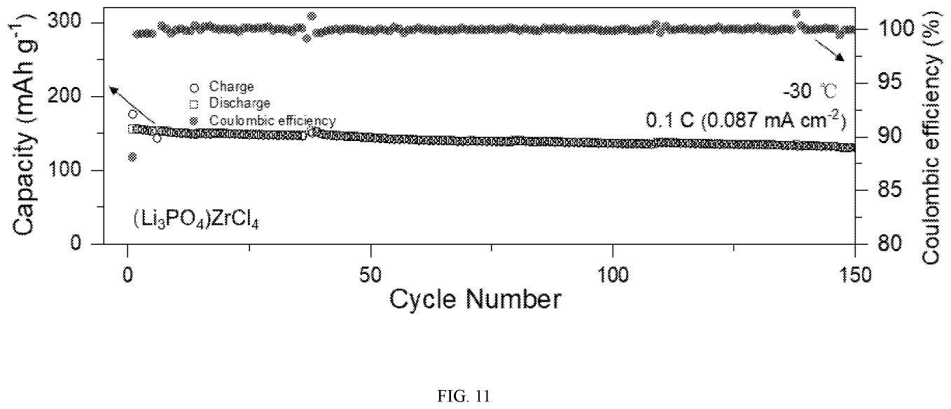

(2) Test Results: The results are as shown in FIG. 11, and the results show that the assembled all-solid-state battery still has a specific capacity of 153 mAh g⁻¹ at low temperature (−30° C.) and a capacity retention of 83.6% after stable cycling for 150 cycles, indicating its excellent low-temperature performance.

What is claimed is:

1. A solid electrolyte, characterized in that a general formula is (CₐN_{b})_{X}_{^{−}}MB_{y};
wherein MB_{y} is van der Waals crystals as a structural framework, and y is a number of atoms of B element; CₐN_{b} is a carrier salt, and a and b are numbers of atoms of cation donors C and anion donors N in the carrier salt, respectively; ₓ is a stoichiometric ratio of CₐN_{b} to MB_{y};
some of the anion donors N are replaced with B positions in MB_{y}, forming a framework structure with carrier ionic migration channels; gaps of the framework structure are filled with dissociated cation donors C.

2. The solid electrolyte according to claim 1, characterized in that the van der Waals crystals are one or more of halide van der Waals crystals, sulfide van der Waals crystals, and oxide van der Waals crystals;
M in the MB_{y} is one or more of Zr, Hf, Ta, Nb, Al, Fe, Ga, In, Mo, W, Y, Ti, Si, B, and Sb; B is one or more of F, Cl, Br, I, S, or O.

3. The solid electrolyte according to claim 1, characterized in that the anion donors N comprise polyanions XOₘⁿ⁻, derivative groups XₘO₃ₘ₊₁ⁿ⁻ of the polyanions, or simple anions;
the simple anions are one or more of halogen, OH⁻, NH₂⁻, O₂²⁻, O²⁻, S²⁻, or N³⁻;
in the polyanions XOₘⁿ⁻ or the derivative groups XₘO₃ₘ₊₁ⁿ⁻ of the polyanions, X is one or more of B, S, P, Si, As, Mo, W, or C; m is 2-4, and n is a number of charges.

4. The solid electrolyte according to claim 3, characterized in that the anion donors N are polyanions XOₘⁿ⁻ or derivative groups XₘO₃ₘ₊₁ⁿ⁻ of the polyanions, and B element in the MB_{y} is substituted with XOₘⁿ⁻ or XₘO₃ₘ₊₁ⁿ⁻.

5. The solid electrolyte according to claim 1, characterized in that the cation donors C are Li⁺, Na⁺, Ag⁺, Cu⁺, or K⁺, wherein a coordination number of Li⁺ ranges from 3 to 5, and a coordination number of Na⁺ ranges from 7 to 9.

6. The solid electrolyte according to claim 1, characterized in that for the dissociated cation donors C, a part is transported as carriers in the framework structure, and the other part forms nanocrystals with MB_{y} or B, wherein a content of the nanocrystals in the solid electrolyte is <30 wt %;
the nanocrystals comprise CₑMB_{f} and CB, wherein e and f in the CₑMB_{f} are stoichiometric numbers of the cation donor C and MB, respectively;
in the framework structure, (CₐN_{b})_{X}_{^{−}}MB_{y} is in a form of particles, CₑMB_{f} or CB is attached to surfaces of the particles, the particles are in an amorphous phase, and the nanocrystals are in a crystalline phase.

7. The solid electrolyte according to claim 1, characterized in that the solid electrolyte (CₐN_{b})_{X}_{^{−}}MB_{y} is of an amorphous or near-amorphous structure, with x ranging from 0.2 to 2 and y ranging from 3 to 6.

8. A preparation method for the solid electrolyte according to claim 1, characterized in that it comprises the following steps:
in an anhydrous and oxygen-free inert atmosphere, mixing CₐN_{b} and MB_{y} according to a stoichiometric ratio by a mechanical ball milling method to make a solid-phase reaction to obtain the solid electrolyte (CₐN_{b})_{X}_{^{−}}MB_{y}.

9. The preparation method for the solid electrolyte according to claim 8, characterized in that control parameters of the mechanical ball milling method comprise:
a diameter of ball milling beads of 3 mm to 10 mm;
a total mass ratio of the ball milling beads to raw materials of 60:1 to 20:1;
a ball milling time of 1 h to 30 h;
a rotation speed of a ball mill of 400 r/min to 800 r/min.

10. A battery, characterized in that it comprises the solid electrolyte according to claim 1.
